(19) United States
(12) Patent Application Publication
(10) Pub. No.: US 2014/0360538 A1
(43) Pub. Date: Dec. 11, 2014

(54) INTRINSICALLY SAFE DRILL CUTTINGS SAMPLE CLEANING STATION

(71) Applicant: Ryan P. Elliott, Wimberley, TX (US)

(72) Inventor: Ryan P. Elliott, Wimberley, TX (US)

(21) Appl. No.: 14/297,363

(22) Filed: Jun. 5, 2014

Related U.S. Application Data
(60) Provisional application No. 61/832,066, filed on Jun. 6, 2013.

(51) Int. Cl. E21B 21/06; B08B 3/04

(52) U.S. Cl. CPC E21B 21/066; B08B 3/04
USPC 134/135

(57) ABSTRACT

An intrinsically safe drill cuttings sample cleaning station includes a frame upon which is dependently supported a mechanical separator, an air dryer and a spin dryer. The mechanical separator provides a bath integrated with a shaker frame. Drill cuttings, and other matter collected with the cuttings, are contained within a sieve basket and washed and/or degreased in the bath while the sieve basket holding the collected drill cuttings and associated matter is shaken by the shaker frame. The drill cuttings sample cleaning station is powered by a remote compressed air source such as, for example, a conventional compressor.

### RELATED APPLICATION

This present application claims priority to, and all available benefit of, U.S. provisional patent application Ser. No. 61/832,066 filed Jun. 6, 2013. By this reference, the full disclosure, including the drawings, of U.S. provisional patent application Ser. No. 61/832,066 is incorporated herein as though now set forth in its entirety.

### FIELD OF THE INVENTION

The present invention relates to drilling operations. More particularly, the invention relates to an intrinsically safe cleaning station for use in cleaning drill cuttings samples in support of drilling operations.

### BACKGROUND OF THE INVENTION

Drill cutting samples are periodically required during oilfield drilling operations for monitoring by a geologist and/or “mud logger” of the formation. In order to obtain an accurate analysis, however, it is critically important that the sample be properly cleaned and, depending upon the specified parameters, dried. To this end, many ad hoc apparatus have been devised in attempts to facilitate the cleaning and, in some cases, drying of drill cuttings samples.

Unfortunately, such prior attempts generally fall short on a number of bases. For example, many make convenient, but generally improper, use of other devices found in and about the drilling rig. In particular, it has often been found that sinks and the like provided for other purposes are utilized in the cleaning operation, leading to contamination of the drilling mud system and/or discharge of hazardous solutions into the environment. Additionally, because the prior attempts generally do not provide a dedicated workspace for the drill cuttings sample cleaning and drying function, the person charged with these responsibilities is often forced to work in areas where he or she is exposed to physical, chemical or other environmental health hazards when such exposure is not otherwise per se necessitated by the specific task at hand. Still further, because the improvised solutions generally require conversion or like utilization of many disparate, and generally distributed, devices, the person charged with performing the cleaning and drying functions is often forced to repeatedly move between locations in the course of preparing even a single sample, resulting in decreased attention to the individual operations, greater rates of error, increased time for completion of the tasks and higher rates of injury due to unnecessary movement through generally hazardous work environments.

With the foregoing in mind, it is therefore an overriding object of the present invention to provide a self-contained and readily transportable cleaning station for use in cleaning and/or otherwise preparing drill cuttings samples in support of drilling operations, whereby such cleaning station may be located away from the most hazardous areas of the drilling site and wherein provision is made for safe and efficient completion of the cleaning and drying tasks as well as proper handling of hazardous materials. Additionally, it is an object of the present invention to provide such a cleaning station that specifically achieves the foregoing object and is also intrinsically safe for utilization in explosion hazard environments.

### SUMMARY OF THE INVENTION

In accordance with the foregoing objects, the present invention—an intrinsically safe drill cuttings sample cleaning station—generally comprises a frame upon which is dependently supported a mechanical separator, an air dryer and a spin dryer. The mechanical separator, as most preferably implemented, provides a bath integrated with a shaker frame such that drill cuttings, and other matter collected with the cuttings, contained within a conventional sieve basket may be washed and/or degreased in the bath while the sieve basket holding the collected drill cuttings and associated matter is shaken by the shaker frame, thereby facilitating the efficient simultaneous cleaning and separation by size of the collected drill cuttings and associated matter. Additionally, provision is made in the most preferred implementation of the present invention for the entire drill cuttings sample cleaning station to be powered by a remote compressed air source such as, for example, a conventional compressor, thereby making the drill cuttings sample cleaning station intrinsically safe for operation explosion hazard areas.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a top plan view, the most preferred implementation of the intrinsically safe drill cuttings sample cleaning station of the present invention;

FIG. 2 shows, in a front elevational view, various details of the intrinsically safe drill cuttings sample cleaning station of FIG. 1; and

FIG. 3 shows, in a schematic diagram, various additional details of the intrinsically safe drill cuttings sample cleaning station of FIG. 1 and, in particular, details of the pneumatic plumbing of the most preferred implementation of the intrinsically safe drill cuttings sample cleaning station of the present invention.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

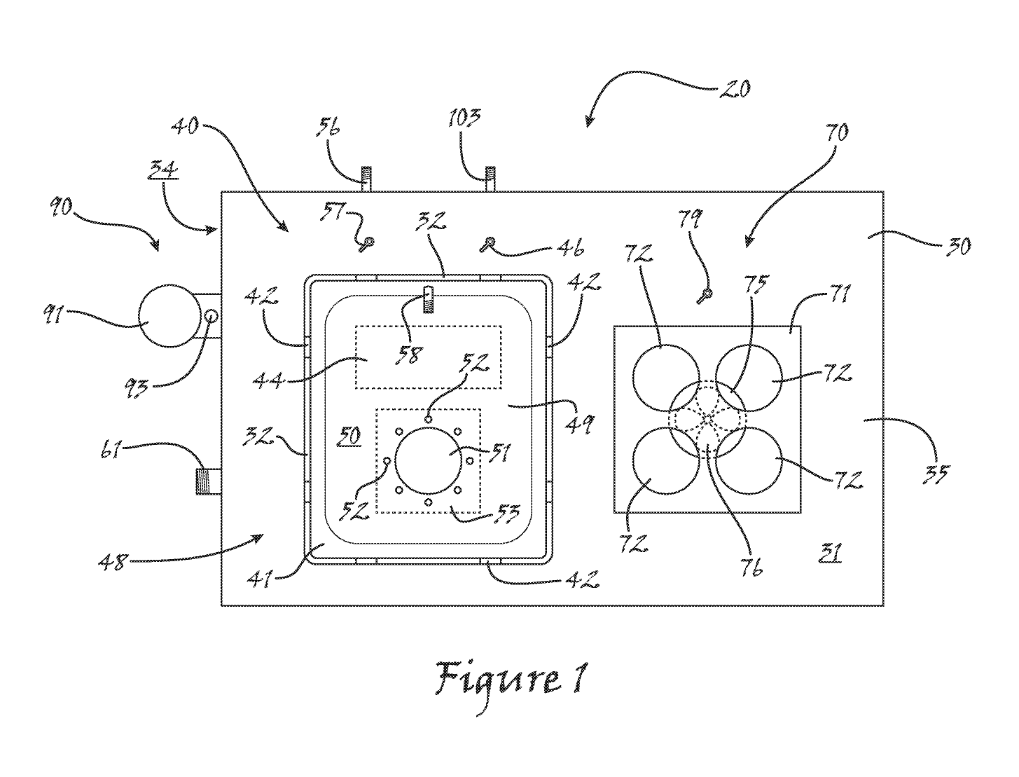

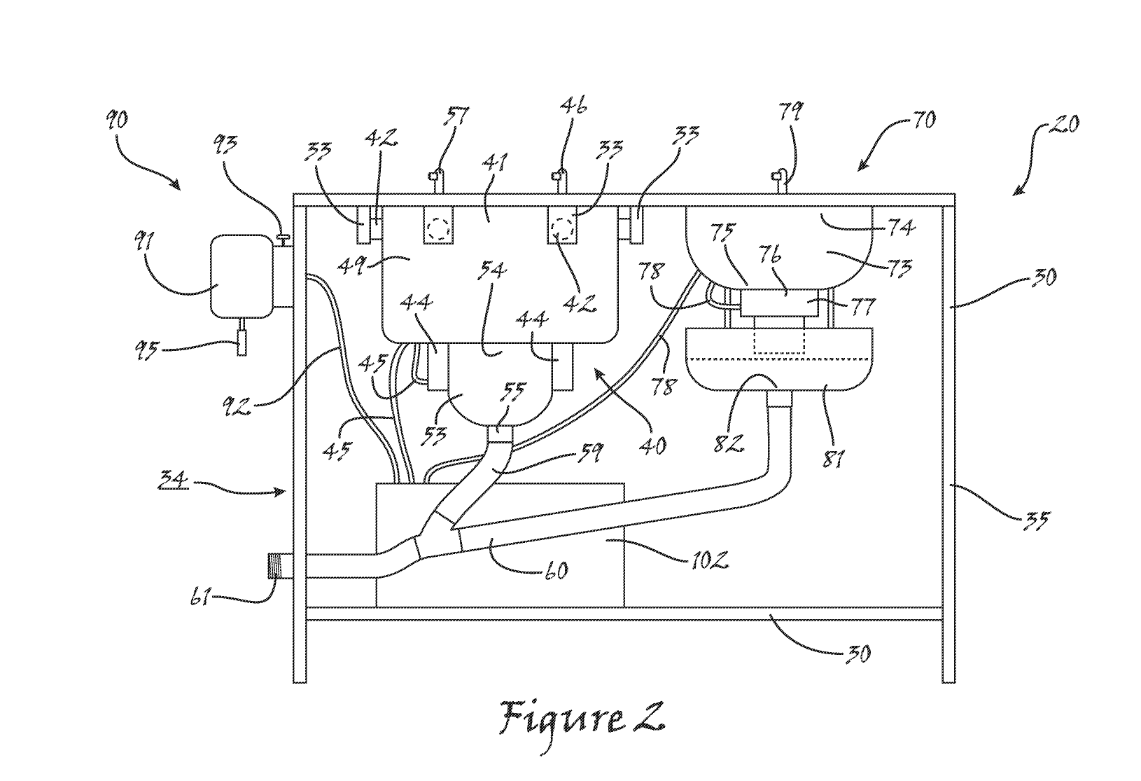

Referring now to the figures, and to FIGS. 1 and 2 in particular, the most preferred implementation of the intrinsically safe drill cuttings sample cleaning station 20 of the present invention is shown to generally comprise a frame 30 upon which is dependently supported a mechanical separator 40, an air dryer 70 and a spin dryer 90. As will be better understood further herein, the mechanical separator 40, as most preferably implemented, provides a bath 48 integrated with a shaker frame 41 such that drill cuttings, and other matter collected with the cuttings, contained within a conventional sieve basket may be washed and/or degreased in the bath 48 while the sieve basket holding the collected drill cuttings and associated matter is shaken by the shaker frame 41, thereby facilitating the efficient simultaneous cleaning and separation by size of the collected drill cuttings and associated matter. As also will be better understood further herein, provision is made in the most preferred implementation of the present invention for the entire drill cuttings sample cleaning station 20 to be powered by a remote compressed air source 100 such as, for example, a conventional compressor 101, thereby making the drill cuttings sample cleaning station 20 intrinsically safe for operation explosion hazard areas.

As those of ordinary skill in the art will recognize in light of this exemplary description (including the foregoing discussions and the discussions to follow, as well), the frame 30 may comprise any number of conventional structures providing a sturdy and stable platform upon which may be mounted the mechanical separator 40, the air dryer 70 and the spin dryer 90, as well as any other associated components as may be implemented. As particularly shown in FIGS. 1 and 2, the frame 30, Applicant has found that the frame 30 may be suitably formed as a steel or like material table 35 having at least a top surface 31, and preferably a side surface 34, for facilitating placement of the various components of the intrinsically safe drill cuttings sample cleaning station 20 of the present invention, as will be better understood further herein.

As also particularly shown in FIGS. 1 and 2, the most preferred implementation of the mechanical separator 40 of the cleaning station 20 of the present invention comprises a shaker frame 41 having affixed thereto a pneumatic turbine or like vibrator 44. In order to prevent vibration of the table 35 (or other implemented frame 30), the shaker frame 41 is mounted to the table 35 through otherwise conventional vibration isolating vibrator mounts 42, such as, for example, spring mounts, rubber mounts or the like, taking care, in any case, the ensure that a gap 32 is otherwise provided between the shaker frame 41 and the main frame 30. As those of ordinary skill in the art will recognize in light of this exemplary description (including the foregoing discussions and the discussions to follow, as well), the provided gap should be sufficiently large to account for the full range of vibratory motion to be expected of the shaker frame 41. In any case, however, the table 35 (or other implemented frame 30) may also be provided with specifically adapted separator mounts 33, such as may comprise steel tongues or the like, to which the provided vibrator mounts 42 may be conveniently interfaced.

As previously mentioned, the mechanical separator 40 also comprises an integrated bath 48, thereby enabling the simultaneous cleaning and separation by size of the collected drill cuttings and associated matter. To this end, Applicant has found it desirable as well as suitable and convenient to implement the shaker frame 41 as a basin 49 that also forms the bath 48. As particularly shown in FIGS. 1 and 2, the basin 49 is provided in its bottom 50 with a sieve socket 51, which is specifically shaped and otherwise adapted to receive and dependently support the base portion of a conventional sieve basket. As those of ordinary skill in the art will recognize in light of this exemplary description (including the foregoing discussions and the discussions to follow, as well), however, a conventional sieve basket received in and supported by the depicted sieve socket 51 will, at least in part, rest above the bottom 50 of the basin 49. As a result, the basin 49 is also provided in its bottom 50 with a plurality of drain holes 52 most preferably disposed about the sieve socket 51.

As those of ordinary skill in the art will recognize in light of this exemplary description (including the foregoing discussions and the discussions to follow, as well), this arrangement ensures that any washing or other fluid introduced into the basin 49 may freely drain from the basin 49 notwithstanding the placement of a sieve basket in the sieve socket 51. In particular, the preferred implementation of the intrinsically safe drill cuttings sample cleaning station 20 of the present invention contemplates inclusion of a washing, degreasing and/or like fluid source. As shown in the figures, such a source may comprise a fluid source nipple 56 or like connector in fluid communication (through a flexible hose or the like) with a faucet nipple 58, or the equivalent thereof, which, as particularly shown in FIG. 1, most preferably is provided on and within the basin 49. As will be appreciated by those of ordinary skill in the art, a fluid flow control valve 57 is interposed the ends of the provided interconnecting flexible hose for selectively turning on or off the flow of washing, degreasing or other fluid. In any case, in order to capture any such fluid, an effluent duct 53 is also provided. As shown in the figures, the inlet 54 to the provided effluent duct 53 is dependently affixed to the underside of the basin 49 about the extents of the sieve socket 51 and drain holes 52. Any fluid passing into through the inlet 54 into the effluent duct 53 is then directed through an outlet 55 of the effluent duct 53, into a flexible drain connector hose 59 and into a provided common drain system 60 or like effluent means. As shown in the figures, and also as those of ordinary skill in the art will recognize in light of this exemplary description (including the foregoing discussions and the discussions to follow, as well), the common drain system 60 may be provided with threaded hose connector 61 or the like for plumbing into an appropriate waste fluid collection and/or disposal system.

As also previously mentioned, the mechanical separator 40 comprises a pneumatic turbine or like vibrator 44 affixed to the shaker frame 41 and adapted to impart vibratory motion to the shaker frame 41. In particular, as shown in FIGS. 1 and 2 for the most preferred implementation of the present invention, the pneumatic turbine vibrator 44 is affixed directly to the underside of the basin 49 forming the combined bath 48 and shaker frame 41. Although any substantially equivalent apparatus may be utilized, Applicant has found that the Model BVS-510HS pneumatic turbine vibrator, as commercially available from VIBCO, Inc. of Wyoming, Rhode Island, is suitable for implementation of the vibrator 44 in accordance with the preferred embodiment of the present invention as depicted and described herein.

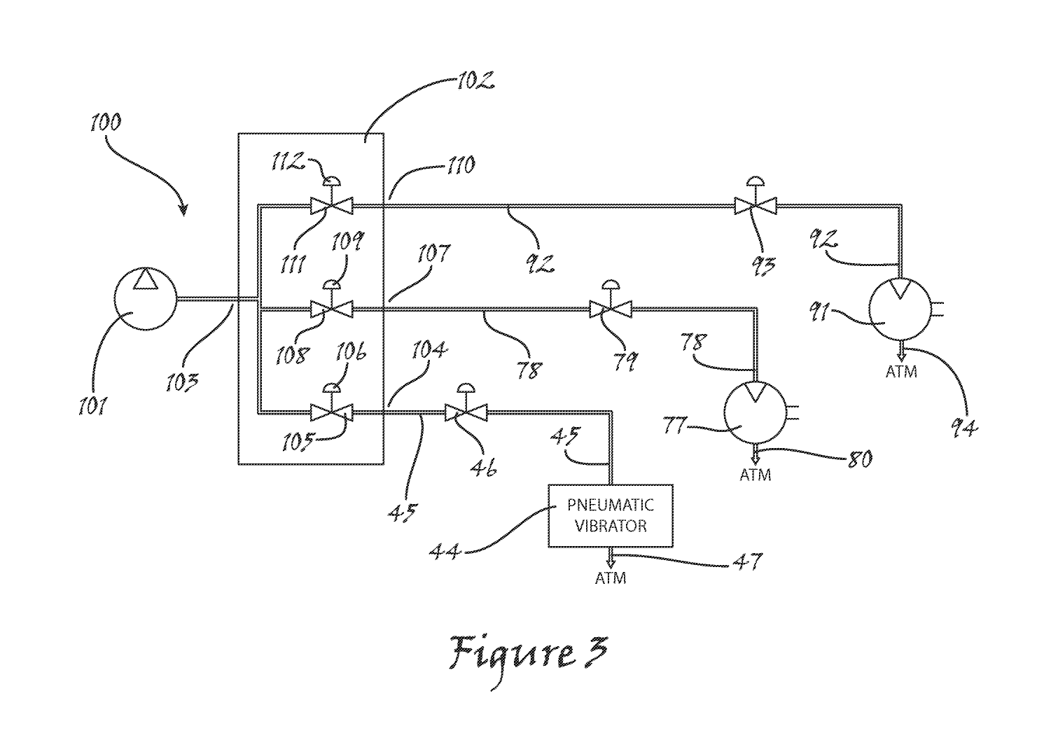

In any case, and as likewise also previously mentioned, the intrinsically safe drill cuttings sample cleaning station 20 is preferably entirely powered by a remote compressed air source 100 such as, for example, a conventional compressor 101. To this end, the most preferred implementation of the present invention comprises a manifold assembly 102, as particularly shown in FIGS. 2 and 3. As shown in the figures, the manifold assembly 102 most preferably comprises a single air inlet 103, thereby facilitating setup for use of the intrinsically safe drill cuttings sample cleaning station 20 of the present invention. Additionally, in order to ensure maximum compatibility with the widest array of compressed air sources 100, the manifold assembly also preferably comprises multiple outlets 104, 107, 110 for separately powering each of the major components of the cleaning station 20 of the present invention, airflow through each outlet being separately controlled by individual pressure regulator valves 105, 108, 111, respectively, according to the needs of the connected major component.

In the most preferred case, then, and as also particularly shown in FIGS. 2 and 3, a supply line 45, having interposed therein an airflow control valve 46, is provided to selectively supply powering airflow to the pneumatic turbine vibrator 44 affixed to the basin 49. As those of ordinary skill in the art will recognize in light of this exemplary description (including the foregoing discussions and the discussions to follow, as well), a user wishing to activate the shaker frame 41 of the mechanical separator 40 will simply open the airflow control valve 46 in the supply line 45 running from the first, mechanical separator outlet 104 of the manifold assembly 102 to the pneumatic turbine vibrator 44, which will cause airflow to pass into the pneumatic turbine vibrator 44 in operation of a conventionally provided pneumatic motor and eccentric weight arrangement. As will be appreciated by those of ordinary skill in the art, such operation will cause the entire shaker frame 41, including all attached components not isolated by the provided vibration isolating vibrator mounts 42 and gap 32 between the shaker frame 41 and the table 35, to vibrate. As will also be appreciated by those of ordinary skill in the art, the user may readily control the degree of vibration in the mechanical separator 40 by adjusting the airflow through the airflow control valve 46. Still further, those of ordinary skill in the art will recognize that because, in the described most preferred implementation, airflow through the first, mechanical separator outlet 104 from the manifold assembly 102 is regulated by the first pressure regulator valve 105, operation of other major components of the cleaning station 20 of the present invention will not inadvertently adversely affect the chosen user setting of the airflow control valve 46 supplying the pneumatic turbine vibrator 44.

As particularly shown in FIGS. 1 and 2, the most preferred implementation of the air dryer 70 of the cleaning station 20 of the present invention comprises a sieve tray 71, preferably formed or otherwise provided in or about the top surface 31 of the table 35 forming the frame 30 of the cleaning station 20, and a preferably high volume blower 76 adapted to conduct airflow through one or more sieve baskets dependently supported by the provided sieve tray 71. As particularly shown in FIG. 2, the sieve tray 71 comprises one or more sieve sockets 72, each of which is specifically shaped and otherwise adapted to receive and dependently support the base portion of a conventional sieve basket. Additionally, an air duct 73 is provided to direct airflow through the provided sieve sockets 72. In particular, as shown in the figures, the inlet 74 to the provided air duct 73 is dependently affixed to the underside of the top surface 31 of the table 35 about the extents of the sieve sockets 72. The outlet 75 from the air duct 73, on the other hand, is fitted with a preferably high volume blower 76, which, in accordance with the object of achieving intrinsic safety, is powered by an air motor 77.

In the most preferred case, then, and as also particularly shown in FIGS. 2 and 3, a supply line 78, having interposed therein an airflow control valve 79, is provided to selectively supply powering airflow to the air motor 77 adapted to drive the high volume blower 76. As those of ordinary skill in the art will recognize in light of this exemplary description (including the foregoing discussions and the discussions to follow, as well), a user wishing to activate the air dryer 70 will simply open the airflow control valve 79 in the supply line 78 running from the second, air dryer outlet 107 of the manifold assembly 102 to air motor 77 of the air dryer 70, which will cause airflow to pass into the air motor 77, thereby driving the high volume blower 76 to draw air through the sieve sockets 72 into the air duct 73 and then through the blower 76 within the outlet 75 of the air duct 73. As will be appreciated by those of ordinary skill in the art, such operation may be hampered in a case where there exist one or more sieve sockets 72 not holding a loaded sieve basket. To this end, as those of ordinary skill in the art will recognize in light of this exemplary description (including the foregoing discussions and the discussions to follow, as well), any unloaded sieve socket 72 may be “corked” with a provided socket plug, such as may readily be formed as a rubber or like material stopper sized and shaped to plug a sieve socket 72. In any case, as will also be appreciated by those of ordinary skill in the art, the user may readily control the volume of airflow through the air dryer 70 by adjusting the airflow through the airflow control valve 79. Still further, those of ordinary skill in the art will recognize that because, in the described most preferred implementation, airflow through the second, air dryer outlet 107 of the manifold assembly 102 is regulated by the second pressure regulator valve 108, operation of other major components of the cleaning station 20 of the present invention will not inadvertently adversely affect the chosen user setting of the airflow control valve 79 supplying the air motor 77 of the air dryer 70.

As those of ordinary skill in the art will recognize in light of this exemplary description (including the foregoing discussions and the discussions to follow, as well), the airflow out of the outlet 75 of the air duct 73 of the air dryer 70 will carry with it at least some liquid matter. Because this liquid matter may be presumed to be at least potentially hazardous, it is important that it should be captured and handled in the manner of the washing, degreasing and/or like fluid. As a result, and a catch basin 81 or like vessel is most preferably provided for capture and handling of any liquid component exiting the air dryer 70. As particularly shown in FIG. 2, the catch basin 81 may conveniently be dependently supported by the underside of the air duct 73 and positioned and otherwise arranged to receive and collect discharged liquids. Although the provided catch basin 81 should be arranged in such a manner as to not materially interfere with the airflow through the outlet 75 from the air duct 73, a screen (as particularly shown in FIG. 2) or similar means may be provided to prevent splatter or the like of any liquid component being discharged through the outlet 75 from the air duct 73. In any case, the provided catch basin 81 or like vessel should comprise an open drain 82 or like effluent means through which any captured liquid component is directed into the provided common drain system 60 or like effluent means, as has been previously described in detail.

As is generally well known to those of ordinary skill in the relevant arts, a conventional spin dryer comprises an electric motor adapted to rotate a drive shaft and operates in concert with a set of dryer cups. In particular, an outer cup comprises a center bearing post upon which is rotatably mounted an inner perforated cup, or “basket.” To this end, the inner cup comprises a center drive post, which has a longitudinal aperture provided therein from the underside of the cup and sized and shaped to fit over the bearing post of outer cup. Additionally, the drive post is adapted to be operably received by the drive shaft of the electric motor, such that, as the electric motor operates the drive shaft spins the inner perforated cup while the nested cups are held in place by an operator. As the inner perforated cup “spins” within the outer cup, centrifugal force causes liquids, in particular, to be “spun” out of the otherwise solid material contained within the inner perforated “basket” cup. Although, as previously mentioned, such conventional spin dryers are generally well known to those of ordinary skill in the relevant arts, it is nonetheless noted that an exemplary conventional spin dryer is commercially available as Part No. 152-80 from OFI Testing Equipment, Inc. of Houston, Tex.

As particularly shown in FIGS. 1 and 2, the most preferred implementation of the spin dryer 90 of the cleaning station 20 of the present invention generally comprises a pneumatic motor 91, preferably mounted to a side surface 34 of the table 35 forming the frame 30 of the cleaning station 20, which operates to rotate a drive shaft 95 extending therefrom. Although the basic operation of the spin dryer 90 of the present invention is generally as conventionally known, it is noted that in a departure from the prior art the spin dryer 90 of the preferred embodiment of the present invention comprises a pneumatic motor 91. To this end, and in keeping with the object of achieving intrinsic safety, a supply line 92 is provides fluid communication of powering airflow from the third, spin dryer outlet 110 of the previously described manifold assembly 102 to the pneumatic motor 92. In order to control airflow through the provided supply line 92, and hence operation of the pneumatic motor 91, a control valve 93 is interposed between the two ends of the supply line 92. As will be appreciated by those of ordinary skill in the art, the user may readily control the supply of airflow to the pneumatic motor 91 by actuating the airflow control valve 93, which may, if desired, have a volume control integrated therein.

Because, like conventional spin dryers, the spin dryer 90 as implemented in accordance with the most preferred embodiment of the present invention contemplates that a user will manually handle the nested cups holding a cuttings sample as the pneumatic motor 91 operates to spin the inner cup, Applicant notes that it is desirable for the airflow control valve 93 to be implemented as a normally closed type valve. In this manner, if the user should become entangled in the moving parts of the spin dryer 90, the pneumatic motor 91 will automatically shut down upon release by the user of the airflow control valve 93. In any case, those of ordinary skill in the art will recognize that because, in the described most preferred implementation, airflow through the third, spin dryer outlet 110 of the manifold assembly 102 is regulated by the third pressure regulator valve 111, operation of other major components of the cleaning station 20 of the present invention will not inadvertently adversely affect the chosen user setting (if implemented) of the airflow control valve 93 supplying the pneumatic motor 91 of the spin dryer 90.

While the foregoing description is exemplary of the preferred embodiment of the present invention, those of ordinary skill in the relevant arts will recognize the many variations, alterations, modifications, substitutions and the like as are readily possible, especially in light of this description and the accompanying drawings. For example, although the pneumatic turbine vibrator 44 of the mechanical separator 40 is shown to comprise an exhaust 47 vented to atmosphere, the air motor 77 of the air dryer 70 is also shown to comprise an exhaust 80 vented to atmosphere and, still further, the pneumatic motor 91 of the spin dryer 90 is likewise shown to comprise an exhaust 94 vented to atmosphere, a more complex valve and plumbing structure may be implemented such that any one or combination of these exhausts 47, 80, 94 may be redirected for use of excess pressures in the powering of other major components.

Additionally, as particularly shown in FIG. 3, adjustments 106, 109, 112 may be provided in the manifold assembly 102 for each of the implemented pressure regulator valves 105, 108, 111, respectively, such that the respective outlets 104, 107, 110 may be conveniently and readily fine tuned for maximum compatibility with particular implementations of the pneumatic turbine vibrator 44 of the mechanical separator 40, the air motor 77 of the air dryer 70 and the pneumatic motor 91 of the spin dryer 90, respectively.

Still further, those of ordinary skill in the art will recognize in light of this exemplary description (including the foregoing discussions and the discussions to follow, as well), will recognize that multiple sieve baskets may readily be stacked within the sieve socket 51 at the bottom 50 of the basin 49 forming the bath 48 of the mechanical separator 40. With this in mind, a cage or like frame may be implemented to ensure that a stack of sieve baskets is not inadvertently tipped over under vibration of the shaker frame 41 while simultaneously providing ready access to the individual sieve baskets for manual washing or the like of the contents thereof.

Likewise, because the faucet nipple 58 is implemented to extend from a portion of the basin 49, as particularly shown in FIG. 1, a spray or nozzle arm may be fitted to the faucet nipple 58 to enable relatively unattended washing, degreasing or the like of the contents of any sieve basket in place within the sieve socket 51. As will be appreciated by those of ordinary skill in the art, especially in light of this exemplary description, the attached spray or nozzle arm will simply move with the remained of the basin 49 under any applied vibratory force, thereby staying in fixed position with respect to the sieve baskets.

Even further, while the table 35 arrangement provides a good workspace for the task at hand, those of ordinary skill in the art will recognize in light of this exemplary description that many other structures may be implemented for the frame 30. Additionally, the frame 30 may be provided with any of the widest variety of mounting hardware for dependent attachment to virtually any structure found in the drilling environment. For example, hooks and/or clamps may be provided and utilized to attach the frame 30 to a fence or equipment railing or other appropriate mounting hardware may be provided and utilized to attach the frame 30 to a wall or a mobile vehicle. Likewise, the table 35 or other structure of the frame 30 may be fitted with casters or other means for facilitating mobility of the cleaning station 20.

Finally, while the most preferred implementation of the present invention contemplates achieving the very important object of intrinsic safety, those of ordinary skill in the art will recognize that, for use in environments not presenting explosion hazards, many of the the teachings of the present invention may be implemented where some or all of the major components of the present invention are realized using electric motors, electromechanical valves and the like. Extra caution should be taken, however, to ensure appropriate measures are implemented to prevent electrical shock hazards concomitant implementation of electrical devices in out of doors and/or otherwise wet environments.

In any case, because the scope of the present invention is much broader than any particular embodiment, the foregoing detailed description should not be construed as a limitation of the scope of the present invention, which is limited only by the claims appended hereto.

What is claimed is:

1. A self-contained, intrinsically safe cleaning station for preparing drill cuttings samples, said cleaning station comprising:
a main frame, said main frame comprising a weldment forming a table;
a mechanical separator, said mechanical separator comprising:
a shaker frame, said shaker frame comprising:
an integrally formed basin, said basin having:
a sieve socket disposed through a lower portion thereof;
a cage positioned about said sieve socket through said lower portion of said basin, said cage being adapted to prevent tipping of a plurality of sieve baskets stacked over said sieve socket through said lower portion of said basin; and
a plurality of drain holes through said lower portion of said basin, said plurality of drain holes being disposed about said sieve socket through said lower portion of said basin; and
a plurality of vibration isolating vibrator mounts, said vibrator mounts being provided and arranged such that said shaker frame is dependently supported through said vibrator mounts from said main frame; and
a pneumatic vibrator, said pneumatic vibrator being affixed to said shaker frame and operatively adapted to impart vibratory motion to said shaker frame;
a cleaning fluid source cooperatively arranged with said basin to dispense a cleaning fluid over and about said sieve socket through said lower portion of said basin;
an air dryer, said air dryer comprising:
a sieve tray provided about a top surface of said table, said sieve tray having a sieve socket formed therethrough; and
a pneumatically powered blower, said blower being adapted to conduct airflow through said sieve socket through said sieve tray;
a pneumatically powered spin dryer dependently mounted to said main frame, said spin dryer comprising:
a first, outer cup;
a second, inner cup rotatably mounted within said first, outer cup; and
a pneumatic motor, said pneumatic motor being adapted to rotate said second, inner cup;
a compressed air source, said compressed air source being in operable fluid communication with said pneumatic vibrator and said pneumatically powered blower; and
a manifold assembly, said manifold assembly comprising:
an air inlet, said air inlet being in fluid communication with said compressed air source;
a plurality of air outlets, each said air outlet having operably associated therewith a pressure regulator valve adapted to individually control airflow through its associated air outlet; and
wherein said pneumatic vibrator, said pneumatically powered blower and said pneumatically powered spin dryer are each in operable fluid communication with said compressed air source through an individual one of said plurality of air outlets.

2. A self-contained, intrinsically safe cleaning station for preparing drill cuttings samples, said cleaning station comprising:
a main frame, said main frame comprising a weldment forming a table;
a mechanical separator, said mechanical separator comprising:
a shaker frame, said shaker frame comprising:
an integrally formed basin, said basin having a sieve socket disposed through a lower portion thereof; and
a plurality of vibration isolating vibrator mounts, said vibrator mounts being provided and arranged such that said shaker frame is dependently supported through said vibrator mounts from said main frame; and
a pneumatic vibrator, said pneumatic vibrator being affixed to said shaker frame and operatively adapted to impart vibratory motion to said shaker frame;
a cleaning fluid source cooperatively arranged with said basin to dispense a cleaning fluid over and about said sieve socket through said lower portion of said basin;
an air dryer, said air dryer comprising:
a sieve tray provided about a top surface of said table, said sieve tray having a sieve socket formed therethrough; and
a pneumatically powered blower, said blower being adapted to conduct airflow through said sieve socket through said sieve tray; and
a compressed air source, said compressed air source being in operable fluid communication with said pneumatic vibrator and said pneumatically powered blower.

3. The cleaning station for preparing drill cuttings samples as recited in claim 2, wherein said compressed air source comprises an air compressor.

4. The cleaning station for preparing drill cuttings samples as recited in claim 3, wherein said pneumatic vibrator comprises a pneumatic turbine.

5. The cleaning station for preparing drill cuttings samples as recited in claim 2, wherein said pneumatic vibrator comprises a pneumatic turbine.

6. The cleaning station for preparing drill cuttings samples as recited in claim 2, wherein said basin comprises a drain hole through said lower portion of said basin, said drain hole being disposed about said sieve socket through said lower portion of said basin.

7. The cleaning station for preparing drill cuttings samples as recited in claim 6, wherein said basin comprises a plurality of drain holes through said lower portion of said basin, said plurality of drain holes being disposed about said sieve socket through said lower portion of said basin.

8. The cleaning station for preparing drill cuttings samples as recited in claim 2, wherein each said vibrator mount comprises a spring mount.

9. The cleaning station for preparing drill cuttings samples as recited in claim 2, wherein each said vibrator mount comprises a rubber mount.

10. The cleaning station for preparing drill cuttings samples as recited in claim 2, wherein said basin comprises a basket frame positioned about said sieve socket through said lower portion of said basin, said basket frame being adapted to prevent tipping of a plurality of sieve baskets stacked over said sieve socket through said lower portion of said basin.

11. The cleaning station for preparing drill cuttings samples as recited in claim 10, wherein said basket frame comprises a cage.

12. The cleaning station for preparing drill cuttings samples as recited in claim 2, said cleaning station further comprising a manifold assembly.

13. The cleaning station for preparing drill cuttings samples as recited in claim 12, wherein said manifold assembly comprises:
an air inlet, said air inlet being in fluid communication with said compressed air source;
a plurality of air outlets, each said air outlet having operably associated therewith a pressure regulator valve adapted to individually control airflow through its associated air outlet; and
wherein said pneumatic vibrator and said pneumatically powered blower are each in operable fluid communication with said compressed air source through an individual one of said plurality of air outlets.

14. The cleaning station for preparing drill cuttings samples as recited in claim 2, said cleaning station further comprising a pneumatically powered spin dryer dependently mounted to said main frame.

15. The cleaning station for preparing drill cuttings samples as recited in claim 14, wherein said spin dryer comprises:
a first, outer cup;
a second, inner cup rotatably mounted within said first, outer cup; and
a pneumatic motor, said pneumatic motor being adapted to rotate said second, inner cup.

16. The cleaning station for preparing drill cuttings samples as recited in claim 15, said cleaning station further comprising a manifold assembly.

17. The cleaning station for preparing drill cuttings samples as recited in claim 16, wherein said manifold assembly comprises:
an air inlet, said air inlet being in fluid communication with said compressed air source;
a plurality of air outlets, each said air outlet having operably associated therewith a pressure regulator valve adapted to individually control airflow through its associated air outlet; and
wherein said pneumatic vibrator, said pneumatically powered blower and said pneumatically powered spin dryer are each in operable fluid communication with said compressed air source through an individual one of said plurality of air outlets.
